(19) United States
(12) Patent Application Publication
(10) Pub. No.: US 2004/0001007 A1
(43) Pub. Date: Jan. 1, 2004

(54) Network terminal haivng a configuration for assigning a network address to another

(75) Inventors: Yoshio Inoue, Tokyo (JP); Takashi Hirosawa, Tokyo (JP); Harufusa Kondoh, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/325,936

(22) Filed: Dec. 23, 2002

(30) Foreign Application Priority Data
Jun. 27, 2002 (JP) 2002-187226

(51) Int. Cl. H04M 11/04; H04Q 1/00

(52) U.S. Cl. 340/825.52; 340/310.01

(57) ABSTRACT

It is an object to automatically and rapidly assign a logical network address to a terminal connected newly to a network. A data holding section (14) of a network terminal (10) holds a value of a self-device address (DA) and information indicating whether the DA has a maximum value in the same network address (NA) or not. When a terminal connected newly to a network transmits address request data for requesting to give an address onto the network, a terminal having the maximum DA at that time transmits DA grant data indicative of a self-address (that is, the maximum DA) as an acknowledgement thereof. A new terminal receiving the DA grant data sets a greater value than the maximum DA to be the self-DA.

### BACKGROUND OF THE INVENTION

1. Field of the Invention

The present invention relates to a technique for assigning an individual logical network address to a network terminal when the network terminal is newly connected to a network.

2. Description of the Background Art

In recent years, a power line communication technology to be a communication method using, as a communication line, a power line wired for supplying a power to a general house, an office and the like has been studied and developed. According to the power line communication, a general power receptacle can be used as a connector to a network. Therefore, attention has been paid as a technique for infiltrating an information communication network into a home or an office. For example, in the home, almost all rooms have power receptacles, and the power receptacles which can be utilized as connectors to a LAN are very convenient if possible. In our country, some products corresponding to the power line communication technology have already been sold and have been used practically.

It is necessary to set an individual logical network address to a terminal (a network terminal) connected to a network such as a LAN and serving to carry out a data communication. In general, the logical network address includes a network address section (hereinafter referred to as “NA”) indicative of a self-network, and a device address section (hereinafter referred to as “DA”) indicative of a self-address in the network. For example, the logical network address attached to an apparatus to be connected to a power line communication network in a general home includes a house address indicative of a self-house or room, and a unit address indicative of an address of each apparatus under the house address, and the house address corresponds to the NA and the unit address corresponds to the DA.

FIG. 8 is a view showing an external appearance of a logical network address setting device provided in a network terminal to be connected to a conventional power line communication network. A logical network address setting device 100 is provided with a rotary switch 101 for house address setting, and a rotary switch 102 for unit address setting. When the network terminal is to be connected to the network, a user first utilizes the rotary switch 101 for house address setting to set a house address (that is, NA) which is uniquely assigned for each house or room to the network terminal, and subsequently utilizes the rotary switch 102 for unit address setting to give a peculiar unit address (that is, DA) to the network device. In other words, the user needs to set both the NA and the DA of the network terminal.

When carrying out DA setting for a terminal to be newly connected to the network, it is necessary to select unused DA so as not to overlap with used DA (which has already been assigned to another terminal). Accordingly, the user needs to store the NA assigned to his (her) house or room and needs to manage the use situation of the DA under the NA. However, if the DA is restricted to such a range as to be easily managed by the user, an extensibility of the network becomes poor. Although a wide range of the DA is desirable, the user manages the DA with difficulty.

Therefore, there have been desired methods of automatically setting a logical network address to each terminal without requiring the management of the use situation of the DA by the user. As one of the methods, an address is given to each terminal by using an apparatus referred to as an address server for managing an address of a network terminal separately from the network terminal. In this method, however, the address server to be a special apparatus is required so that a cost is increased correspondingly.

Moreover, there is also a method of automatically setting a logical network address without using the address server. In this method, a terminal requiring address setting first inquires an address which is being used of all terminals on a LAN through a broadcast (that is, a transmission to addresses for receipt of all the terminals). Each terminal gives its own address through the broadcast in response to the inquiry. Consequently, a terminal requiring the address setting can know used addresses in the LAN, and reversely, can also know unused addresses. One of the unused addresses is selected to be its own address. In this method, however, all the terminals on the LAN simultaneously give their own addresses through the broadcast in response to the inquiry. Therefore, there is a possibility that a LAN medium might be brought into a congestion state, resulting in a non-smooth communication.

As another method in which the address server is not used, furthermore, a method using a confirmation frame has been proposed. In this method, a terminal requiring address setting first selects a temporary address (an interim address) properly and transmits, through a broadcast, a confirmation frame for confirming whether the interim address has already been used or not. A terminal receiving the confirmation frame returns a rejection frame indicating that the interim address has already been used only if the interim address is coincident with its own address. A terminal transmitting the confirmation frame repeats the above operation as long as the rejection frame is returned. In the case in which the rejection frame is not returned, the interim address is decided to be unused and is set to be a self-address. In this method, only a terminal having the same address as the interim address carries out a response to the confirmation frame. Therefore, the LAN medium can be prevented from being brought into the congestion state. However, the interim address is selected by a random number, a predetermined function or the like, for example. For this reason, the unused address cannot be always selected immediately. In that case, the selection of the interim address, the transmission of the confirmation frame and response waiting from each terminal are repetitively carried out. Consequently, there is a possibility that a time required for determining an address might be increased.

### SUMMARY OF THE INVENTION

It is an object of the present invention to provide a network terminal capable of automatically and rapidly assigning a logical network address to a network terminal which is newly connected to a network.

A first aspect of the present invention is directed to a network terminal to be connected to a network to carry out a data transmission and receipt, including a transmitting section, a receiving section and a data holding section. The transmitting section serves to carry out the data transmission. The receiving section serves to carry out the data receipt. The data holding section serves to hold a self-address on the network and information indicating whether the self-address is a maximum over the network or not. When the receiving section receives address request data for requesting an address to be given transmitted from another network terminal, the transmitting section transmits address data indicative of the self-address onto the network if the self-address is a maximum over the network based on the information held by the data holding section.

It is preferable that another network terminal transmitting the address request data should receive the address data to set, as a self-address, a greater address than the address indicated by the address data. Consequently, it is possible to prevent the same address from being repetitively set to a plurality of network terminals. More specifically, it is not necessary to confirm or inquire whether the address has already been used or not. Accordingly, it is possible to automatically and rapidly assign an address to the network terminal.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a structure of a main part of a network terminal according to a first embodiment,

FIG. 2 is a diagram for explaining an operation of the network terminal according to the first embodiment,

FIG. 3 is a flow chart showing the operation of the network terminal according to the first embodiment,

FIG. 4 is a diagram for explaining the operation of the network terminal according to the first embodiment,

FIGS. 5 and 6 are flow charts showing the operation of the network terminal according to the first embodiment,

FIG. 7 is a diagram for explaining an operation of a network terminal according to a second embodiment, and

FIG. 8 is a view showing an external appearance of a logical network address setting device provided in a conventional network terminal to be connected to a power line communication network.

### DESCRIPTION OF THE PREFERRED EMBODIMENTS

<First Embodiment>

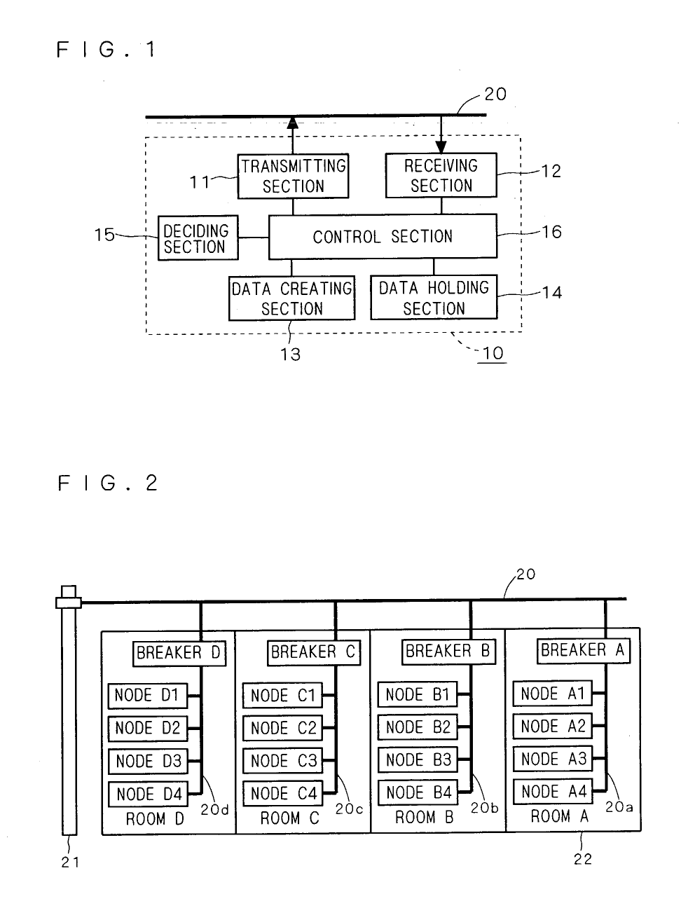

FIG. 1 is a block diagram showing a structure of a main part of a network terminal according to the present embodiment. A network terminal 10 has a transmitting section 11, a receiving section 12, a data creating section 13, a data holding section 14, a deciding section 15 and a control section 16 for controlling their operations, and is connected to a network line 20. The transmitting section 11 transmits data created by the data creating section 13 to another terminal through the network line 20. Moreover, a header of the data created by the data creating section 13 includes a control bit indicating that the data are “data on an inquiry about whether interim NA has already been used” (which will be hereinafter referred to as “an interim NA inquiry control bit”), a control bit indicating that the data are “data on an NA notification” (which will be hereinafter referred to as an “NA notification control bit”), and a control bit indicating that the data are “data on a DA grant” (which will be hereinafter referred to as a “DA grant control bit”).

The receiving section 12 receives data from another terminal through the network line 20. The data holding section 14 holds a value of a self-logical network address (NA and DA) and information indicating whether self-holding DA has a maximum value in DA held by a terminal belonging to the same NA as its own NA (which will be hereinafter referred to as a “maximum DA flag”). The deciding section 15 decides whether data received by the receiving section 12 are directed to the deciding section 15 itself or not and whether a response is to be given or not based on information included in the received data and information held by the data holding section 14.

FIG. 2 is a diagram for explaining an operation of the network terminal according to the present embodiment. A power line communication network is shown as an example of a network. The application of the present invention is not restricted thereto but the present invention can also be applied to networks having various communication configurations.

With reference to FIGS. 1 and 2, description will be given to the operation of the network terminal according to the present embodiment. A condominium 22 has rooms A to D which share the network line (common power line) 20. The rooms A to D are provided with indoor wirings 20a to 20d branching from the common power line 20 through breakers (circuit breakers) A to D, respectively. More specifically, a power line communication network is constituted by the common power line 20 and the indoor wirings 20a to 20d. Moreover, each of nodes A1 to A4, B1 to B4, C1 to C4 and D1 to D4 owned by the rooms is the network terminal 10 according to the present embodiment shown in FIG. 1. A terminal of the power line communication network includes various electric apparatuses such as general household appliances, for example, an air conditioner, a video and a lighting fixture in addition to communication apparatuses such as a telephone, a facsimile and the like as well as a personal computer. Their terminals are connected to a network through a power receptacle.

A network in the room A has not been started (that is, the breaker A is OFF). It is assumed that the network is to be newly started to set a logical network address of each node in the room A. Moreover, it is assumed that the other rooms (B to D) have already been connected to the network and a logical network address has been set to each terminal. Furthermore, it is assumed that NA of the logical network address is to be separately defined for each room.

When the breaker A in the room A is turned ON, a power is supplied to the indoor wiring 20a and the network in the room A is started so that the nodes A1 to A4 are connected to the network. When the nodes A1 to A4 detect that they are newly connected to the network, they start an operation for setting their logical network addresses (NA and DA).

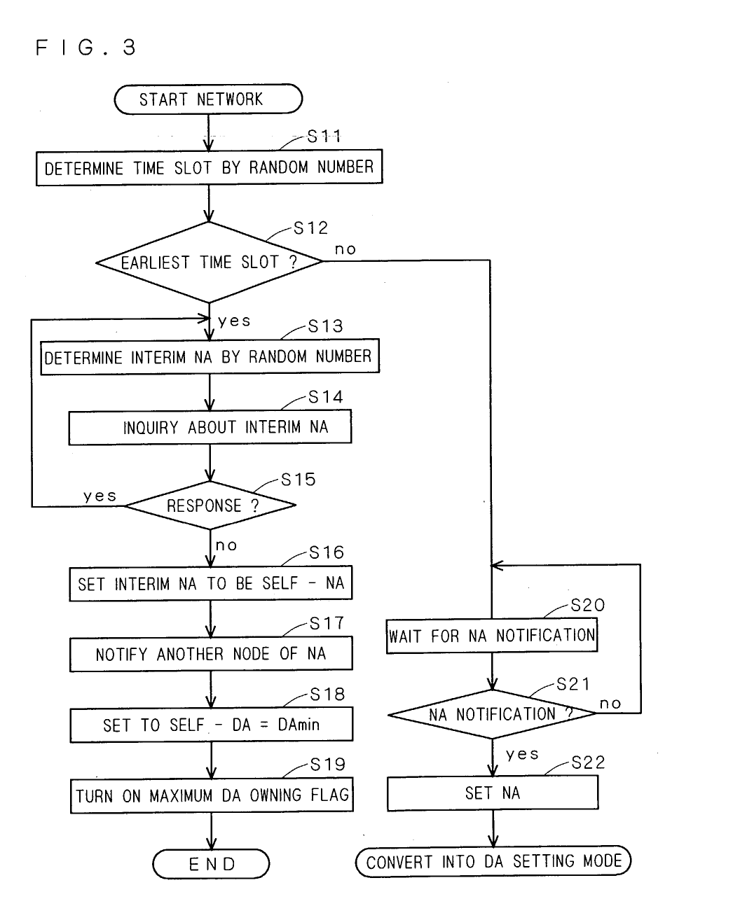

FIG. 3 is a flow chart showing an operation of a network terminal (node) according to the present embodiment at time of network starting. When the network is started so that the nodes A1 to A4 are connected to the network, the control section 16 of each of the nodes A1 to A4 first sets its own NA to “Don't Care” and determines a time slot to be a timing in which it starts a data transmission (S11). At this time, when a large number of nodes are assigned to the same time slot, a data collision is apt to be caused, thereby impeding a smooth data transmission. For this reason, a random number is used for the assignment to each time slot in such a manner that the node is uniformly assigned to the time slot.

Then, any of the nodes A1 to A4 to which the earliest time slot is assigned determines temporary NA (interim NA) by the random number (S12 and S13). Thereafter, interim NA inquiry data in which an NA inquiry control bit is ON are created, by the data creating section 13, as data on an inquiry about whether the interim NA has already been used, and are broadcast through the transmitting section 11 (S14). More specifically, in the interim NA inquiry data, the interim NA inquiry control bit is ON and an NA field to be a source is “Don't Care”.

On the other hand, the other nodes stand by until the NA is determined (S20). The decision whether or not the time slot is the earliest in the step S12 can be carried out based on a decision whether or not the interim NA inquiry data have already been received from the other nodes before broadcasting, for example.

For convenience of the description, it is assumed that the earliest time slot is assigned to the node A1.

Since the interim NA inquiry data are transmitted from the node A1 through the broadcast, they are received by all the nodes of the rooms B to D. Each of the nodes receives the interim NA inquiry data through the receiving section 12. The deciding section 15 decides that the received data are the interim NA inquiry data because the interim NA inquiry control bit is ON and the NA field to be the source is “Don't Care”. Then, the interim NA indicated by the interim NA inquiry data is extracted and it is decided whether or not the interim NA thus extracted is coincident with self-NA held by the data holding section 14. If the interim NA is coincident with the self-NA, the data creating section 13 creates interim NA rejection data in which the interim NA inquiry control bit is ON as data for rejecting that the interim NA is repetitively set, and returns the interim NA rejection data by a broadcast through the transmitting section 11. More specifically, in the interim NA rejection data, the interim NA inquiry control bit is ON and the NA field to be the source is the interim NA obtained at that time.

At this time, if all the nodes having the same NA as the interim NA return the interim NA rejection data, there is a possibility that a LAN medium might be brought into a congestion state, resulting in a non-smooth communication. Therefore, it is desirable that one predetermined node should return the interim NA rejection data. Examples of the node to carry out the return include a node assigned to the earliest time slot which has the same NA as the interim NA, a node having maximum DA (that is, a node in which the “maximum DA flag” is ON”) and the like.

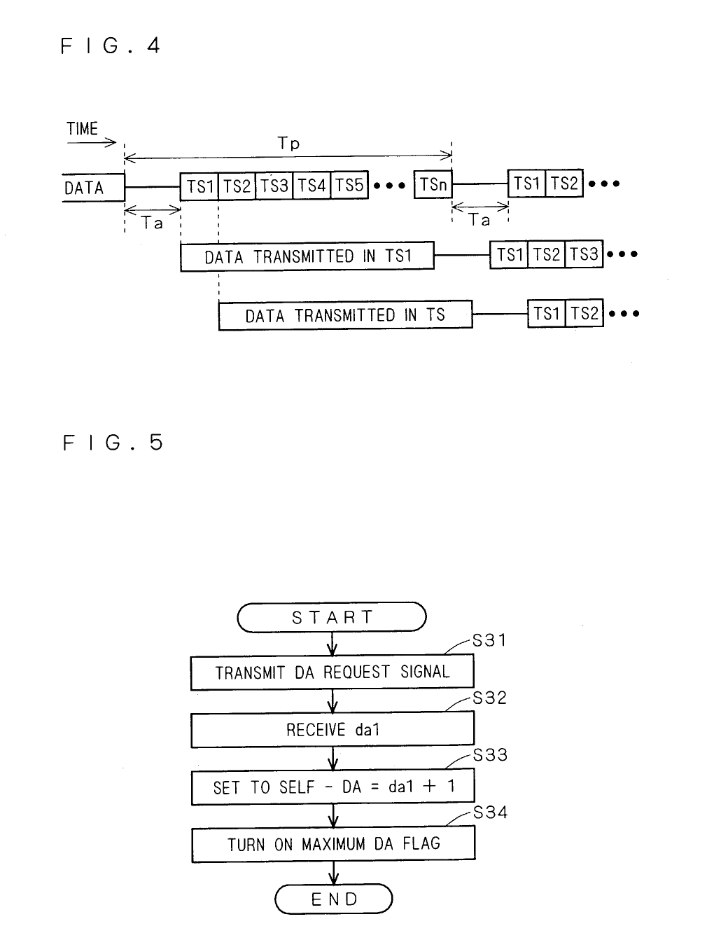

The node A1 giving the interim NA inquiry waits for a response from the other nodes for a predetermined waiting time (S15). In the case in which the interim NA rejection data are received as the response from the other nodes, the operations of the steps S13 to S15 are repeated as long as the response is given. The waiting time in the step S15 is to be so long as to confirm that a response is not given from any node over at least the network. For example, in the case in which each node starts to transmit data in any timing in a series of time slots TS1 to TSn shown in FIG. 4 and a data transmission prohibition period Ta is present before and after the time slots TS1 to TSn, it is preferable that the waiting time should be determined to be equal to or longer than a period Tp shown in FIG. 4.

On the other hand, in the case in which the interim NA rejection frame is not returned after the standby for the predetermined waiting time, the node A1 decides that the interim NA is unused and sets the interim NA as its own NA (S16). The set NA is held in the data holding section 14. By the above operations, the NA in the room A is set.

When the NA is defined, the node A1 creates NA notification data in which an NA notification control bit is ON as data for a notification of the NA by means of the data creating section 13, and transmits the NA thus acquired through the broadcast. More specifically, in the NA notification data, the NA notification control bit is ON and the NA field to be the source is not “Don't Care”.

The deciding section 15 in each node decides that the NA notification data are to be received only if the self-NA is “Don't Care”. In other words, the NA notification data transmitted from the node A1 are received by only the nodes A2 to A4 in which the NA has not been set. Upon receipt of the NA notification data, the nodes A2 to A4 set the notified NA to be their own addresses (S21 and S22). The nodes A2 to A4 having the NA set are subsequently converted into a mode for setting DA.

On the other hand, the node A1 transmitting the NA notification data sets its own DA to have a possible minimum value (DAmin) of the DA (S18) and turns ON the maximum DA flag of its own data holding section 14 (S19).

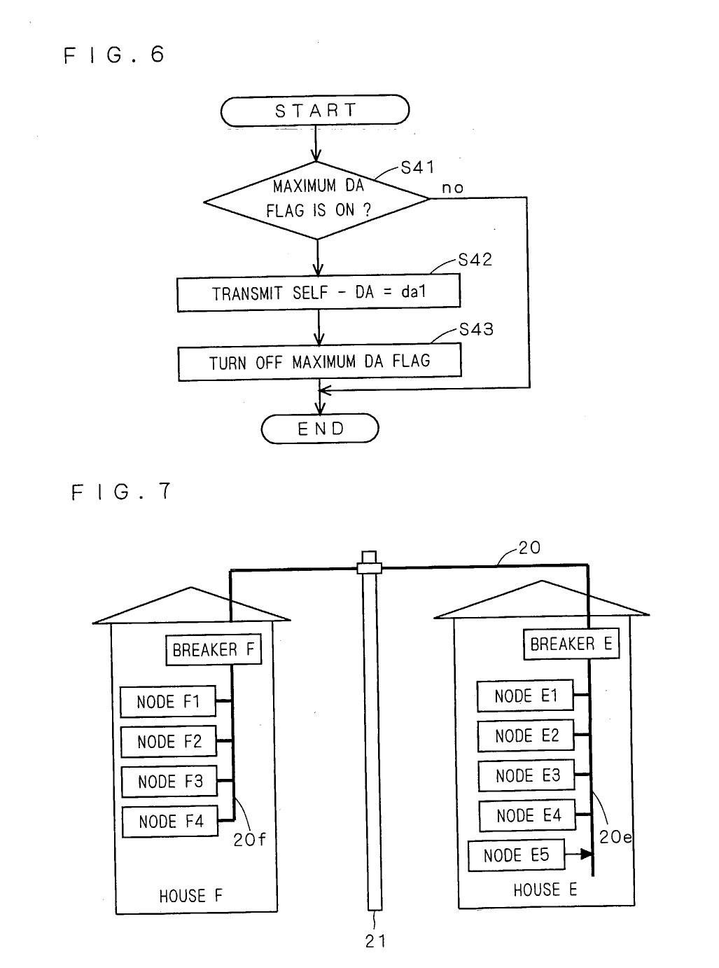

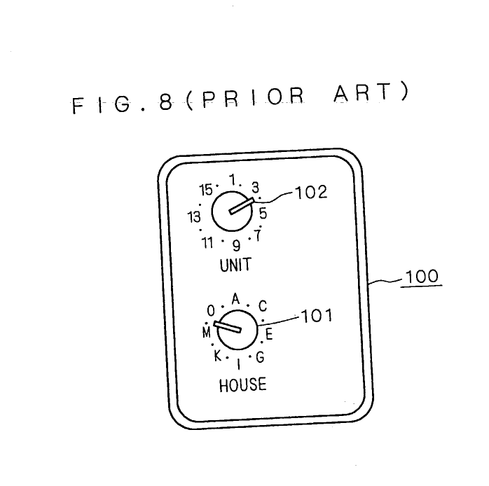

FIGS. 5 and 6 are flow charts showing a DA setting operation of a network terminal according to the present embodiment. FIG. 5 shows an operation of a node to set the DA and FIG. 6 shows an operation of a node in which the maximum DA flag is ON. With reference to these drawings, description will be given to the DA setting operation in the nodes A2 to A4.

The operation for setting the DA is sequentially carried out from the earliest time slot in the nodes A2 to A4. On the assumption that the network terminal to set the DA is the node A2, the description will be given. The node A2 creates DA request data in which a DA grant control bit is ON as data for requesting the DA to be given in the data creating section 13. More specifically, in the DA request data, the DA grant control bit is ON and a DA field to be a source is “Don't Care”.

Then, the node A2 transmits the DA request data as an acknowledgement (ACK) request frame through the transmitting section 11 (S31). At this time, self-NA (that is, NA in the room A) is used for the NA field to be the source by the above operations. Accordingly, the DA request data transmitted from the node A2 are received by only the nodes A1, A3 and A4 having the same NA as that of the node A2.

The deciding section 15 of each node receiving the DA request data confirms whether the maximum DA flag of the data holding section 14 is ON or not (S41). If the maximum DA flag is ON, the deciding section 15 decides to return an acknowledgement (ACK) frame. Then, the data creating section 13 creates DA grant data in which a DA grant control bit is ON as data indicative of self-DA (assumed to be “da1”), that is, maximum DA at that time. More specifically, in the DA grant data, the DA grant control bit is ON and the DA field to be the source is not “Don't Care”.

Herein, the maximum DA flag of the node A1 is ON. Therefore, the node A1 transmits DA grant data indicative of self-DA (=DAmin) as the ACK frame (S42). Subsequently, the node (node A1) transmitting the ACK frame turns OFF its own maximum DA flag (S43).

Since the ACK frame is received by only the node transmitting the ACK request frame, the DA grant data transmitted from the node A1 are received by only the node A2 (S32). The node A2 extracts da1 (DAmin) from the received DA grant data and sets self-DA to be da1+1 (DAmin+1) (S33). More specifically, the self-DA is set to have a greater value than da1. Then, the self-maximum DA flag is turned ON (S34). By the above operations, the DA is completely set by the node A2.

Description will be given to the reason why the DA request data and the DA grant data to be an acknowledgement thereof are transmitted as the ACK request frame and the ACK frame, respectively. For instance, in the case in which the node A2 transmits the DA request data as normal data which are not the ACK request frame in the above example, the DA grant data to be transmitted, as a response, by the node A1 are also set to be normal data which are not the ACK frame. At this time, the DA grant data are to be transmitted through a broadcast such that the node A2 having the DA undecided can receive the same DA grant data. When the DA grant data are transmitted through the broadcast, they are also received by the nodes A3 and A4 having the DA undecided in addition to the node A2. The nodes A3 and A4 cannot recognize that the same DA grant data are directed to the node A2. As a result, the nodes A2 to A4 assign the same DA to themselves based on the same DA grant data. In other words, in the case in which there are a plurality of nodes to be newly connected to a network to set the DA, drawbacks are caused.

On the other hand, if the DA request data and the DA grant data are set to be the ACK request frame and the ACK frame respectively as in the present embodiment, the DA grant data are received by only a terminal transmitting the DA request data. In other words, the DA request data and the DA grant data can be exchanged one-on-one. Also in the case in which there are a plurality of terminals to be newly connected to the network to set the DA, therefore, it is possible to prevent the terminals from receiving the same DA grant data so that it is possible to prevent the same DA from being repetitively set to the terminals.

It is assumed that the node A3 starts to set its own DA after the node A2 completely sets the DA. When the node A3 transmits DA request data as an ACK request frame, the node A2 in which the maximum DA flag is ON transmits DA grant data as an ACK frame at this time. As a result, the maximum DA flag of the node A2 is turned OFF. On the other hand, in the node A3, the DA is set to be DAmin+2 and the maximum DA flag is turned ON. Since the same operation as described above is carried out at this time, description will be omitted. When the node A4 finally sets its own DA in the same manner, the DA is set to be DAmin+3 and the maximum DA flag is turned ON in the node A4.

By the above operations, the logical network address is completely assigned to all the nodes in the room A.

In the present embodiment, thus, each node holds the maximum DA flag indicating that the node itself has maximum DA and only the node in which the maximum DA flag is ON gives an acknowledgement to the DA request data. Therefore, it is possible to prevent a data collision and the congestion state of the network line at time of the DA assignment. Moreover, DA given by a DA grant data has a maximum value at that time. By assigning a greater value than the maximum value to the self-DA, consequently, it is possible to prevent the DA from being repetitively given without confirming or inquiring whether the DA has already been used or not. Accordingly, it is possible to rapidly give the logical network address.

In the present embodiment, moreover, the DA request data and the DA grant data to be an acknowledgement thereof are transmitted as the ACK request frame and the ACK frame, respectively. Therefore, the DA grant data are received by only the terminal transmitting the DA request data. Also in the case in which there are a plurality of terminals to be newly connected to the network to set the DA (terminals having the DA unset) over the same network, accordingly, it is possible to prevent the terminals from receiving the same DA grant data. In other words, it is possible to prevent the same DA from being repetitively set to the terminals.

In the case in which the node repeats a connection to the network and a disconnection therefrom and continuously gives the DA by the above method, the maximum DA reaches a possible maximum value even if the number of the nodes connected to the network is not increased. Consequently, new DA cannot be assigned even if the unused DA is present. Preferably, an information interchange of the DA is periodically carried out between the nodes, the number of the nodes which are currently connected to the network is confirmed and the DA is reassigned according to the number of the nodes thus confirmed, thereby resetting the maximum DA.

<Second Embodiment>

As described above, in the first embodiment, the terminal to set the DA transmits the DA request data as the ACK request frame and the terminal in which the maximum DA flag is ON transmits, as the ACK frame, the DA grant data indicative of its own DA (that is, the maximum value of the DA which is used at that time) in response thereto. Also in the case in which there are a plurality of terminals to be newly connected to the network to set the DA (terminals having the DA unset), consequently, it is possible to prevent the terminals from receiving the same DA grant data so that it is possible to prevent the same DA from being repetitively set to the terminals.

If only one terminal is to set the DA, however, it is possible to prevent the same DA from being repetitively set to the terminals without using an ACK request frame and an ACK frame. In the present embodiment, such a case will be taken as an example.

FIG. 7 is a diagram for explaining an operation of a network terminal according to the present embodiment. As an example of the network, a power line communication network is shown. The operation of the network terminal according to the present embodiment will be described below. A house E and a house F share a network line (a common power line) 20 and are provided with indoor wirings 20e and 20f branching from the common power line 20 through breakers (circuit breakers) E and F, respectively. More specifically, the power line communication network is constituted by the common power line 20 and the indoor wirings 20e and 20f.

For simplicity of the description, it is assumed that a data interchange cannot be carried out between the houses E and F. Also in an actual power line communication network system, a signal transmitted through a common power line is attenuated so that a communication cannot be carried out because a distance between the houses is sufficiently great, and a blocking filter is provided in such a manner that a signal does not leak from the house to the outside. In many cases, thus, a signal cannot be transmitted between the houses.

Nodes E1 to E5 and F1 to F4 of the houses E and F are network terminals shown in FIG. 1, respectively. In the present embodiment, moreover, the node E5 has a switch, a push button or the like (not shown) for starting an operation for setting its own logical network address (NA and DA), and starts the setting operation by a user's manipulation.

The nodes E1 to E4 and F1 to F4 are terminals which have already been connected to the network and to which inherent logical network addresses are set. On the other hand, the node E5 is a terminal to be newly connected to the network to set the logical network address. Moreover, it is assumed that NA of the logical network address is individually determined for each house.

When the operation for setting its own logical network address is started as instructed by the user, the node E5 first sets its own NA to “Don't Care”. Subsequently, a data creating section 13 creates data to request a notification of the NA (NA notification request data) in which an NA notification control bit is ON. More specifically, in the NA notification request data, the NA notification control bit is ON and an NA field to be a source is “Don't Care”.

Then, a deciding section 15 successively monitors data transmitted over the network through a receiving section 12 (carrier sense). If the data are not transmitted over the network, it is decided that a data transmission can be carried out and the NA notification request data are transmitted by a broadcast through a transmitting section 11.

The NA notification request data transmitted from the node E5 are received by the nodes E1 to E4. Upon receipt of the NA notification request data, the nodes E1 to E4 recognize that a new node (node E5) is connected to the network. In a predetermined one of the nodes E1 to E4, the data creating section 13 creates NA notification data for notifying a new node of its own NA (that is, NA of the house E) (that is, data in which the NA notification control bit is ON and the NA field to be the source is not “Don't Care”), and the transmitting section 11 transmits the same NA notification data through the broadcast.

Examples of one predetermined node to transmit the NA notification data include a node which is assigned to the earliest time slot, a node having maximum DA (that is, a node in which a “maximum DA flag” is ON) and the like.

Only in the case in which self-NA is “Don't Care”, the deciding section 15 of each node decides to receive the NA notification data. More specifically, the NA notification data are received by only the node E5. Upon receipt of the NA notification data, the node E5 extracts the NA of the house E from the same data and provisionally determines the same NA as its own NA. Then, if other NA notification data do not arrive again after a standby for a predetermined time, it is decided that the provisionally determined NA is to be its own NA (the NA of the house E) and is formally set to be the self-NA.

When the NA is completely set by the above operations, the node E5 subsequently sets its own DA in the same procedure as the flow charts of FIGS. 5 and 6 described in the first embodiment. In the present embodiment, only the node E5 is a terminal to be newly connected to the network to set the DA. Therefore, it is possible to carry out a one-to-one data communication between a node connected newly to the network and a node in which a maximum DA flag is ON without using an ACK request frame and an ACK frame. More specifically, it is preferable that a node receiving DA request data should transmit DA grant data as an acknowledgement only when its own maximum DA flag is ON, while a node receiving the DA grant data should set the DA only when its own DA is “Don't Care”.

As in the present embodiment, in the case in which the terminals are newly connected to the network to set the self-NA one by one, it is possible to prevent the same DA from being repetitively set to a plurality of terminals even if the DA request data and the DA grant data are transmitted and received through a normal data communication using neither the ACK request frame nor the ACK frame.

While the invention has been shown and described in detail, the foregoing description is in all aspects illustrative and not restrictive. It is therefore understood that numerous modifications and variations can be devised without departing from the scope of the invention.

What is claimed is:

1. A network terminal to be connected to a network to carry out a data transmission and receipt, comprising:
a transmitting section for carrying out said data transmission;
a receiving section for carrying out said data receipt; and
a data holding section for holding a self-address on said network and information indicating whether said self-address is a maximum over said network or not,
wherein when said receiving section receives address request data for requesting an address to be given transmitted from another network terminal, said transmitting section transmits address data indicative of said self-address onto said network if said self-address is a maximum over said network based on said information held by said data holding section.

2. The network terminal according to claim 1, wherein said transmitting section transmits said address request data at time of a new connection to said network,
said receiving section receives address data transmitted from another network terminal, and
said data holding section holds, as a self-address, a greater address than an address indicated by said address data received by said receiving section.

3. The network terminal according to claim 1, wherein said address request data are of a type of ACK (Acknowledgement) request frame, and
said address data are of a type of ACK frame to be an acknowledgement for said ACK request frame.
